(19) United States
(12) Patent Application Publication
(10) Pub. No.: US 2019/0230933 A1
(43) Pub. Date: Aug. 1, 2019

(54) Tomato Treatment

(71) Applicant: Phyton Corporation, Bloomington, MN (US)

(72) Inventor: William Gullickson, Bloomington, MN (US)

(21) Appl. No.: 16/262,486

(22) Filed: Jan. 30, 2019

Related U.S. Application Data
(60) Provisional application No. 62/623,910, filed on Jan. 30, 2018.

(51) Int. Cl. A01N 59/20; A01N 59/16

(52) U.S. Cl. CPC A01N 59/20; A01N 59/16

(57) ABSTRACT

Processes for treating tomato plants with copper-containing compositions are provided. The treated plants display increased fruit yield, increased fruit weight, and/or increased copper uptake.

### CLAIM OF PRIORITY

This application claims priority to U.S. Provisional Application Ser. No. 62/623,910, filed on Jan. 30, 2018, the entire contents of which are hereby incorporated by reference.

### TECHNICAL FIELD

This invention relates to treatments for tomato plants, and more particularly to providing copper-containing treatments to tomato plants for increasing yield, copper uptake, and essential nutrient uptake in the tomato plants.

### BACKGROUND

Copper is an essential nutrient of plants, and can be involved in plant metabolic processes such as photosynthesis and respiration. The bioavailability of copper in some soils is limited, and some growing practices, including certain types of fertilization, can lead to lower copper bioavailability. Copper deficiency in plants can lead to sterility and decreased yields, while excess application of copper can be toxic to plants.

### SUMMARY

This document provides methods for treating tomato plants with copper-containing compositions. In some embodiments, the copper-containing compositions are copper biocide compositions. In some embodiments, the methods can include applying an aqueous composition comprising from about 1% to about 6% by weight copper metal at an application rate of about 50 ml/ha to about 2000 ml/ha.

Some exemplary methods described herein include applying copper biocide compositions to tomato plants at low concentrations or amounts. For example, in some embodiments, the copper-containing compositions are applied such that each hectare of plants receives about 1.00 g copper to about 80.00 g copper. In some embodiments, the methods described herein may include applying a first application of copper-containing compositions to tomato plants at or before panicle initiation.

In one aspect, a method is provided herein for treating a tomato plant. The method includes applying a first application of an aqueous composition to the plant. The aqueous compositions can comprise a copper compound, and the amount of copper metal in the composition is from about 1% to about 6% by weight based on the weight of the composition. The aqueous composition can be applied to one or more plants at an application rate of about 200 ml per hectare to about 1200 ml per hectare to form a treated plant.

In some implementations, the first application can be applied at about 20 days to about 40 days after seed germination. In some implementations, the first application can be applied at about 30 days after germination of the tomato plant. The first application can include an application rate of about 1.00 g copper metal per hectare to about 80.00 g copper metal per hectare. In some implementations, the first application can be a foliar spray application.

In some implementations, the composition can further comprise tannic acid. In some implementations, the composition can further comprise ammonium formate. The composition can, in some implementations, comprise a tannate complex of picro cupric ammonium formate in aqueous solution.

In some implementations, the copper compound in the aqueous composition can be selected from, e.g., copper sulfate, copper chlorate, copper nitrate, copper chloride, and combinations thereof. In some implementations, the composition can further comprise a zinc compound. The amount of zinc metal in can be between 1% and 5% by weight based upon the weight of the composition. The zinc compound can be a water-soluble zinc compound selected from, e.g., zinc sulfate, zinc chlorate, zinc nitrate, zinc chloride, and combinations thereof. In some implementations, the composition can further comprise a manganese compound. The amount of manganese metal can be between 0.1% and 0.5% by weight of the composition. The manganese compound can be a water-soluble manganese compound selected from the group consisting of manganese sulfate, manganese chlorate, manganese nitrate, manganese chloride, and combinations thereof. In some implementations, the composition can further comprise a surfactant. The surfactant can include an alkali metal alkyl sulfate, such as sodium lauryl sulfate.

In some implementations, the method can further comprise applying to the treated plant a second application of the aqueous composition. The second application can be applied at an application rate of about 200 ml per hectare to about 1200 ml per hectare. In some implementations, the second application can be applied to the treated plant at about 50 days to about 70 days after germination. In some implementations, the second application can be applied to the treated plant at about 60 days after germination. In some implementations, the second application can be applied to the treated plant from about 20 days to about 50 days after the first application. In some implementations, the second application can be applied to the treated plant from about 30 days after the first application. The second application can include an application rate of about 1.00 g copper metal per hectare to about 80.00 g copper metal per hectare. In some implementations, the second application can be a foliar spray application.

In some implementations, a fruit yield of a treated plant can be greater than a fruit yield of an untreated plant of the same plant variety grown under similar conditions for a similar amount of time. In some implementations, the fruit yield of a treated plant is at least 5% greater than the fruit yield of an untreated plant of the same plant variety grown under conditions for a similar amount of time. In some implementations, copper uptake in a treated plant is greater than copper uptake in an untreated plant of the same plant variety grown under similar conditions for a similar amount of time. In some implementations, the average weight of a fruit of the treated plant is greater than the average weight of a fruit of an untreated plant grown under similar conditions for a similar amount of time. In some implementations, the average weight of a fruit of the treated plant is at least 5% greater than the average weight of a fruit of an untreated plant grown under similar conditions for a similar amount of time. The methods can be practiced on a variety of tomato species.

The methods described herein can provide several advantages. First, applying copper-containing compositions according to the methods described herein can lead to increased copper uptake in tomato plants. Copper is an essential plant nutrient and is involved in several metabolic processes in tomato plants, including activation of the reproductive cycle. Since copper is typically immobile in plants, correction of copper deficiency can be complicated. However, in some embodiments, increasing copper uptake by the methods described herein can correct copper deficiencies in the plants.

Second, applying copper-containing compositions according to the methods described herein can lead to increased uptake of essential plant nutrients. Essential plant nutrients keep plants healthy, protect plants from disease, and aid in plant reproduction.

Third, applying copper-containing compositions according to the methods described herein can lead to increased yield in the plants. In some embodiments, plants treated by the methods described herein exhibit increased biomass, increased plant matter yield, increased average fruit weight, and/or increased fruit yield.

Fourth, applying copper-containing compositions according to the methods described herein can, in some embodiments, provide copper to the plants without resulting in toxic effects. Copper-containing compositions have traditionally been applied to plants as a biocide in somewhat high concentrations to protect against bacteria, fungi, and other diseases. Typically these applications of copper-containing biocides occur at late plant life cycle stages to reduce toxicity to the plant, but late stage application of copper does not supply the copper essential for earlier life cycle stages such as reproduction. High application rates of copper can be toxic to plants, particularly at early life cycle stages. Additionally, copper-containing compositions are not typically applied to tomato plants, even as biocides at late life cycle stages, since copper can have a phytotoxic effect on tomato fruit. However, in some embodiments, copper-containing compositions applied according to the methods described herein do not produce toxic effects in the tomato plants.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

For the terms “for example” and “such as,” and grammatical equivalences thereof, the phrase “and without limitation” is understood to follow unless explicitly stated otherwise. As used herein, the term “about” is meant to account for variations due to experimental error. As used herein, the singular forms “a,” “an,” and “the” are used interchangeably and include plural referents unless the context clearly dictates otherwise.

As used herein, the term “compound” includes hydrates.

Also herein, the recitations of numerical ranges by endpoints include all numbers subsumed within that range (e.g., 1 to 5 includes 1, 1.5, 2, 2.75, 3, 3.80. 4, 5, etc.).

Other features and advantages of the invention will be apparent from the following detailed description and figures, and from the claims.

### DETAILED DESCRIPTION

The present disclosure is directed to methods of treating tomato plants such as Plantuff, Beef Steak, Roma, and other varieties, by applying copper-containing compositions to the plants. It has been surprisingly discovered that, in some embodiments, application of copper-containing compositions ordinarily used as biocides can have advantageous effects on the nutrient composition and yield of plants when applied at lower concentrations and different life cycle stages than when used as biocides.

Copper-containing compositions useful in the methods described herein can contain from about 1% to about 6% by weight copper metal. In some embodiments, the copper-containing compositions contain from about 4% to about 6% by weight copper metal, from about 1% to about 2% by weight copper metal, from about 1.5% to about 1.6% by weight copper metal, from about 1.9% to about 2.0% by weight copper metal, from about 4.3% to about 4.4% by weight copper metal, from about 5.3% to about 5.5% by weight copper metal.

The compositions can be applied to a particular plant or target area in one or more applications as needed. In some embodiments, the copper-containing compositions can be applied to the plants as a first application, or as first and second applications, to form a treated plant. The typical field application rate, or amount, per hectare can range from about 50 ml per hectare to about 2000 ml per hectare, about 200 ml per hectare to about 1200 ml per hectare, about 400 ml per hectare to about 1100 ml per hectare, about 500 ml per hectare to about 1000 ml per hectare, about 400 ml per hectare to about 600 ml per hectare, or about 900 to about 1100 ml per hectare. In some embodiments, the copper-containing compositions can be applied to the plants in a first application, or first and second applications, at an application rate of about 530 ml/ha to about 560 ml/ha per application. In some embodiments, the copper-containing compositions can be applied to the plants in a first application, or first and second applications, at an application rate of about 550 ml/ha per application. In some embodiments, the copper-containing compositions can be applied to the plants in a first application, or first and second applications, at an application rate of about 1080 ml/ha to about 1120 ml/ha per application. In some embodiments, the copper-containing compositions can be applied to the plants in a first application, or first and second applications, at an application rate of about 1100 ml/ha per application. In some embodiments, the second application can be applied at the same rate or amount as the first application, while in other embodiments, the second application can have a different application rate or amount.

In some embodiments, the first and/or second application can include applying the compositions at a rate, or amount, of, for example, about 1.00 g copper metal per hectare to about 80.00 g copper metal per hectare, about 1.70 g copper metal per hectare to about 77.00 g copper metal per hectare, about 1.00 g copper metal per hectare to about 5.00 g copper metal per hectare, about 1.70 g copper metal per hectare to about 1.80 g copper metal per hectare, about 70.00 g copper metal per hectare to about 80.00 g copper metal per hectare, or about 76.00 g copper metal per hectare to about 77.00 g copper metal per hectare. In some embodiments, the first and/or second application can include applying the compositions at a rate of about 1.78 g copper metal per hectare per application. In some embodiments, the first and/or second application can include applying the compositions at a rate of about 76.8 g copper metal per hectare per application.

In some embodiments, the copper-containing compositions are applied to the tomato plants at certain life stages. Tomato plants undergo multiple life stages. Initially, tomato seeds germinate from about 5 days to about 15 days after planting and enter a vegetative state. Next, about 10 days to about 30 days after germination, the plants enter a first flowering stage. First fruit set can occur around 5 days to 15 days after first flowering, and fruit growth stage occurs from about 10 days to about 30 days after first flowering. Harvest can begin about 15 to 25 days after onset of fruit growth and can last from about 20 days to about 150 days. The length and timing of each stage can differ depending on the tomato cultivar and growing conditions such as weather conditions.

In some embodiments, a first application of a copper-containing composition is applied to a tomato plant prior to first flowering. In some embodiments, a first application of a copper-containing composition is applied to a tomato plant prior to first fruit set. In some embodiments, a first application of a copper-containing composition is applied to a tomato plant at about 20 days to about 40 days after seed germination. In some embodiments, a first application of a copper-containing composition is applied to a tomato plant at about 30 days after seed germination. In some embodiments, a second application of a copper-containing composition described herein can be applied to the treated plant during first fruit set, prior to fruit growth, or during fruit growth stage. In some embodiments, a second application of a copper-containing composition described herein can be applied to the treated plant at about 50 days to 70 days after germination, or about 60 days after germination. In some embodiments, the second application can be applied about 20 days to about 50 days after the first application, or about 30 days after the first application. In some embodiments, the second application can be applied at the same rate or amount as the first application, while in other embodiments, the second application can have a different application rate or amount.

The copper-containing compositions can be applied directly to the plant surfaces, such as directly to the foliage of the plant, in the processes described herein, using conventional techniques, such as spraying, painting, or dipping. In some embodiments, the first application of copper-containing compositions is applied by foliar application, which can include spraying the composition on at least a portion of the plant. In some embodiments, the second application of copper-containing compositions is applied by foliar application.

Copper-containing compositions useful in the methods described herein can include a copper compound in which the amount of copper metal is between 1% and 6% by weight based upon the weight of the composition. Examples of suitable copper compounds include water-soluble copper compounds such as copper sulfate, copper chlorate, copper nitrate, copper chloride, and combinations thereof.

In some embodiments, the copper-containing compositions can also include tannic acid. In some embodiments, the copper-containing compositions can include ammonium formate. The copper-containing compositions can also include one or more surfactants. In some embodiments, the surfactant can be an alkali metal alkyl sulfate, such as sodium lauryl sulfate.

The copper-containing compositions useful in the methods described herein can be prepared by combining the ingredients in an agriculturally-acceptable non-toxic carrier, such as an aqueous carrier. Other ingredients may be included as well. Examples of suitable additional ingredients include tannic acid, picric acid, pigments (e.g., SMC white, which can also function as a solvent/carrier) to facilitate visualization upon application to a plant surface, and ammonium salts (e.g., ammonium formate). If desired, agents to adjust the viscosity and/or adherent properties of the composition may be included. Examples include water-soluble polymers such as polyvinylpyrrolidone, polyoxyethylene, polyvinyl alcohol, and polyacrylamide.

In some embodiments, the copper-containing compositions can comprise a tannate complex of picro cupric ammonium formate in aqueous solution. The compositions can further comprise a surfactant. In some embodiments, the tannate complex of picro cupric ammonium formate is comprised of one mole of a water soluble copper salt reacted with 2 to 2.9 moles of ammonium formate, and for each 100 parts by dry weight of cupric ammonium formate the complex includes from about 2 to 5 parts by weight of picric acid and about 0.5 to 3.5 parts by weight of tannic acid combined with about 2 to 10 parts by weight of surfactant sufficient to prevent separation of the tannate complex. In some embodiments, the tannate complex can be admixed in amount from about 0.05 to about 60 percent with an agriculturally acceptable non-toxic carrier.

Copper-containing compositions useful in the methods described herein can, in some embodiments, further comprise a zinc compound. Examples of suitable zinc compounds include water-soluble zinc compounds selected from zinc sulfate, zinc chlorate, zinc nitrate, zinc chloride, and combinations thereof. The amount of zinc metal in the composition can be between 1% and 5% by weight based upon the weight of the composition.

In some embodiments, the copper-containing compositions can further include a manganese compound. Examples of suitable manganese compounds include water-soluble manganese compounds selected from the group consisting of manganese sulfate, manganese chlorate, manganese nitrate, manganese chloride, and combinations thereof. The amount of manganese metal in the composition can be between 0.1% and 0.5% by weight based upon the weight of the composition.

In some embodiments, application of the copper-containing compositions can lead to increased copper uptake in the treated plant, as compared to a similar untreated plant of the same variety or cultivar grown under similar conditions, for a similar amount of time. In some embodiments, the copper uptake may increase throughout all parts of the plant in similar amounts.

Application of the copper-containing compositions can, in some embodiments, lead to increased uptake in the treated plant of one or more essential nutrients, such as calcium, iron, magnesium, manganese, potassium, selenium, zinc, or combinations thereof, as compared to a similar untreated plant of the same variety or cultivar grown under similar conditions, for a similar amount of time.

In some embodiments, application of the copper-containing compositions can lead to increased yield in the treated plant as compared to a similar untreated plant of the same variety or cultivar grown under similar conditions, for a similar amount of time. Increased yield can refer to, for example, increased biomass yield, increased plant matter yield, increased fruit yield, or increased fruit weight, or a combination thereof, as compared to a similar untreated plant of the same variety or cultivar grown under similar conditions, for a similar amount of time. Fruit yield can refer to the number of fruits or tomatoes produced by the tomato plants. Fruit weight can refer to individual fruit weights, average fruit weights, or total fruit weight of a harvest in a given harvest area. In some embodiments, application of the copper-containing compositions can lead to at least at least a 1%, at least a 5%, at least an 8%, at least a 10%, at least a 12%, at least a 15%, at least a 20%, at least a 25%, at least a 30%, at least a 35%, at least a 39%, or at least a 40% increase in fruit yield or plant matter yield as compared to an untreated plant. In some embodiments, application of the copper-containing compositions can lead to at least at least a 5%, at least an 8%, at least a 10%, at least a 12%, at least a 15%, at least a 20%, at least a 25%, at least a 26%, or at least a 30% increase in fruit weight, average fruit weight, or total fruit weight, as compared to an untreated plant.

Plants treated by the processes described herein can include a variety of tomato plants, such as Plantuff, Beef Steak, Roma, and other varieties.

In some embodiments of the method, the compositions are applied to plants that have been determined to be deficient in copper. Copper deficiency in tomato plants can be determined by conventional means, such as by plant symptoms (e.g., curled leaves), or by elemental analysis. In some embodiments of the method, the compositions are applied to plants growing in soil that has been determined to be deficient in copper. Copper deficiency in soil can be determined by conventional means, such as by sampling soil at one or more depths. As can be appreciated, a determination of whether a soil or a plant is deficient in copper can depend on the particular plant type and plant variety.

Some non-limiting exemplary embodiments are shown in embodiments 1-51 below:

Embodiment 1. A method of treating a tomato plant comprising:

applying to said plant a first application of an aqueous composition comprising a copper compound in which the copper metal is from about 1% to about 6% by weight based on the weight of the composition, at an application rate of about 200 ml per hectare to about 1200 ml per hectare to form a treated plant.

Embodiment 2. The method of embodiment 1, wherein said first application is applied at about 20 days to about 40 days after seed germination.

Embodiment 3. The method of embodiment 1, wherein said first application is applied at about 25 days to about 35 days after seed germination.

Embodiment 4. The method of embodiment 1, wherein said first application is applied at about 30 days after seed germination.

Embodiment 5. The method of any one of embodiments 1-4, wherein said first application comprises applying said composition at an application rate of about 500 ml per hectare to about 1150 ml per hectare.

Embodiment 6. The method of any one of embodiments 1-4, wherein said first application comprises applying said composition at an application rate of about 530 ml per hectare to about 560 ml per hectare.

Embodiment 7. The method of any one of embodiments 1-4, wherein said first application comprises applying said composition at an application rate of about 1080 ml per hectare to about 1120 ml per hectare.

Embodiment 8. The method of any one of embodiments 1-7, wherein said first application of said composition comprises applying said composition at an application rate of about 1.00 g copper metal per hectare to about 80.00 g copper metal per hectare.

Embodiment 9. The method of any one of embodiments 1-7, wherein said first application of said composition comprises applying said composition at an application rate of about 1.70 g copper metal per hectare to about 77.00 g copper metal per hectare.

Embodiment 10. The method of any one of embodiments 1-7, wherein said first application of said composition comprises applying said composition at an application rate of about 1.00 g copper metal per hectare to about 10.00 g copper metal per hectare.

Embodiment 11. The method of any one of embodiments 1-7, wherein said first application of said composition comprises applying said composition at an application rate of about 60.00 g copper metal per hectare to about 80.00 g copper metal per hectare.

Embodiment 12. The method of any one of embodiments 1-11, wherein said composition further comprises:

tannic acid.

Embodiment 13. The method of any one of embodiments 1-12, wherein said composition further comprises:

ammonium formate.

Embodiment 14. The method of any one of embodiments 1-13, wherein said composition comprises a tannate complex of picro cupric ammonium formate in aqueous solution.

Embodiment 15. The method of any one of embodiments 1-14, wherein said copper compound is a water-soluble copper compound selected from the group consisting of copper sulfate, copper chlorate, copper nitrate, copper chloride, and combinations thereof.

Embodiment 16. The method of embodiment 15, wherein said water-soluble copper compound is copper sulfate.

Embodiment 17. The method of any one of embodiments 1-16, wherein said composition further comprises:

a zinc compound.

Embodiment 18. The method of embodiment 17, wherein the amount of zinc metal in said zinc compound is between 1% and 5% by weight based upon the weight of said composition.

Embodiment 19. The method of any one of embodiments 17-18, wherein said zinc compound is a water-soluble zinc compound selected from the group consisting of zinc sulfate, zinc chlorate, zinc nitrate, zinc chloride, and combinations thereof.

Embodiment 20. The method of any one of embodiments 1-19, wherein said composition further comprises:

a manganese compound.

Embodiment 21. The method of embodiment 20, wherein the amount of manganese metal in said manganese compound is between 0.1% and 0.5% by weight of said composition.

Embodiment 22. The method of any one of embodiments 20-21, wherein said manganese compound is a water-soluble manganese compound selected from the group consisting of manganese sulfate, manganese chlorate, manganese nitrate, manganese chloride, and combinations thereof.

Embodiment 23. The method of any one of embodiments 1-22, wherein said composition further comprises a surfactant.

Embodiment 24. The method of embodiment 23, wherein said surfactant is an alkali metal alkyl sulfate.

Embodiment 25. The method of any one of embodiments 23-24, wherein said surfactant is sodium lauryl sulfate.

Embodiment 26. The method of any one of embodiments 1-25, wherein said first application is a foliar spray application.

Embodiment 27. The method of any one of embodiments 1-26, further comprising applying to said treated plant a second application of said composition at an application rate of about 200 ml per hectare to about 1200 ml per hectare.

Embodiment 28. The method of embodiment 27, wherein said second application is applied to said treated plant at about 50 days to 70 days after germination.

Embodiment 29. The method of embodiment 27, wherein said second application is applied to said treated plant at about 55 days to 65 days after germination.

Embodiment 30. The method of embodiment 27, wherein said second application is applied to said treated plant at about 60 days after germination.

Embodiment 31. The method of embodiment 27, wherein said second application is applied to said treated plant at about 20 days to about 50 days after said first application.

Embodiment 32. The method of embodiment 27, wherein said second application is applied to said treated plant at about 25 days to about 40 days after said first application.

Embodiment 33. The method of embodiment 27, wherein said second application is applied to said treated plant at about 30 days after said first application.

Embodiment 34. The method of any one of embodiments 27-33, wherein said second application is a foliar spray application.

Embodiment 35. The method of any one of embodiments 27-34, wherein said second application comprises applying said composition at an application rate of about 500 ml per hectare to about 1000 ml per hectare.

Embodiment 36. The method of any one of embodiments 27-34, wherein said second application comprises applying said composition at an application rate of about 500 ml per hectare to about 1150 ml per hectare.

Embodiment 37. The method of any one of embodiments 27-34, wherein said second application comprises applying said composition at an application rate of about 530 ml per hectare to about 560 ml per hectare.

Embodiment 38. The method of any one of embodiments 27-34, wherein said second application comprises applying said composition at an application rate of about 1080 ml per hectare to about 1120 ml per hectare.

Embodiment 39. The method of any one of embodiments 27-34, wherein said second application comprises applying said composition at an application rate of about 1.00 g copper per hectare to about 80.00 g copper per hectare.

Embodiment 40. The method of any one of embodiments 27-34, wherein said second application comprises applying said composition at an application rate of about 1.70 g copper per hectare to about 77.00 g copper per hectare.

Embodiment 41. The method of any one of embodiments 27-34, wherein said second comprises applying said composition at an application rate of about 1.00 g copper metal per hectare to about 10.00 g copper metal per hectare.

Embodiment 42. The method of any one of embodiments 27-34, wherein said first application of said composition comprises applying said composition at an application rate of about 60.00 g copper metal per hectare to about 80.00 g copper metal per hectare.

Embodiment 43. The method of any one of embodiments 1-42, wherein a fruit yield of said treated plant is greater than a fruit yield of an untreated plant grown under similar conditions for a similar amount of time.

Embodiment 44. The method of embodiment 43, wherein said fruit yield of said treated plant is at least 5% greater than the fruit yield of an untreated plant grown under similar conditions for a similar amount of time.

Embodiment 45. The method of embodiment 43, wherein said fruit yield of said treated plant is at least 10% greater than the fruit yield of an untreated plant grown under conditions for a similar amount of time.

Embodiment 46. The method of embodiment 43, wherein said fruit yield of said treated plant is at least 15% greater than the fruit yield of an untreated plant grown under conditions for a similar amount of time.

Embodiment 47. The method of any one of embodiments 1-46, wherein copper uptake in said treated plant is greater than copper uptake in an untreated plant grown under similar conditions for a similar amount of time.

Embodiment 48. The method of any one of embodiments 1-47, wherein an average weight of a fruit of said treated plant is greater than an average weight of a fruit of an untreated plant grown under similar conditions for a similar amount of time.

Embodiment 49. The method of embodiment 48, wherein the average weight of a fruit of said treated plant is at least 5% greater than an average weight of a fruit of an untreated plant grown under similar conditions for a similar amount of time.

Embodiment 50. The method of embodiment 48, wherein the average weight of a fruit of said treated plant is at least 15% greater than an average weight of a fruit of an untreated plant grown under similar conditions for a similar amount of time.

Embodiment 51. The method of embodiment 48, wherein the average weight of a fruit of said treated plant is at least 25% greater than an average weight of a fruit of an untreated plant grown under similar conditions for a similar amount of time.

### Other Embodiments

A number of embodiments of the invention have been described. It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of treating a tomato plant comprising:
applying to said plant a first application of an aqueous composition comprising a copper compound in which the copper metal is from about 1% to about 6% by weight based on the weight of the composition, at an application rate of about 200 ml per hectare to about 1200 ml per hectare to form a treated plant.

2. The method of claim 1, wherein said first application is applied at about 20 days to about 40 days after seed germination.

3. The method of claim 1, wherein said first application of said composition comprises applying said composition at an application rate of about 1.00 g copper metal per hectare to about 80.00 g copper metal per hectare.

4. The method of claim 1, wherein said composition further comprises:
tannic acid, ammonium formate, a zinc compound, a manganese compound, a surfactant, or combinations thereof.

5. The method of claim 1, wherein said composition comprises a tannate complex of picro cupric ammonium formate in aqueous solution.

6. The method of claim 1, wherein said copper compound is a water-soluble copper compound selected from the group consisting of copper sulfate, copper chlorate, copper nitrate, copper chloride, and combinations thereof.

7. The method of claim 4, wherein composition comprises a zinc compound and the amount of zinc metal in said zinc compound is between 1% and 5% by weight based upon the weight of said composition.

8. The method of claim 4, wherein said zinc compound is a water-soluble zinc compound selected from the group consisting of zinc sulfate, zinc chlorate, zinc nitrate, zinc chloride, and combinations thereof.

9. The method of claim 4, wherein the composition comprises a manganese compounds and the amount of manganese metal in said manganese compound is between 0.1% and 0.5% by weight of said composition.

10. The method of claim 4, wherein said manganese compound is a water-soluble manganese compound selected from the group consisting of manganese sulfate, manganese chlorate, manganese nitrate, manganese chloride, and combinations thereof.

11. The method of claim 4, wherein composition comprises a surfactant said surfactant is an alkali metal alkyl sulfate.

12. The method of claim 1, wherein said first application is a foliar spray application.

13. The method of claim 1, further comprising applying to said treated plant a second application of said composition at an application rate of about 200 ml per hectare to about 1200 ml per hectare.

14. The method of claim 13, wherein said second application is applied to said treated plant at about 50 days to 70 days after germination or about 20 days to about 50 days after said first application.

15. The method of claim 13, wherein said second application is a foliar spray application.

16. The method of claim 13, wherein said second application comprises applying said composition at an application rate of about 1.00 g copper per hectare to about 80.00 g copper per hectare.

17. The method of claim 1, wherein a fruit yield of said treated plant is greater than a fruit yield of an untreated plant grown under similar conditions for a similar amount of time.

18. The method of claim 1, wherein copper uptake in said treated plant is greater than copper uptake in an untreated plant grown under similar conditions for a similar amount of time.

19. The method of claim 1, wherein an average weight of a fruit of said treated plant is greater than an average weight of a fruit of an untreated plant grown under similar conditions for a similar amount of time.

20. The method of claim 19, wherein the average weight of a fruit of said treated plant is at least 5% greater than an average weight of a fruit of an untreated plant grown under similar conditions for a similar amount of time.
